(19) United States
(12) Patent Application Publication
(10) Pub. No.: US 2025/0116888 A1
(43) Pub. Date: Apr. 10, 2025

(54) TEMPLE SIDE WING STRUCTURE

(71) Applicant: PROHERO GROUP CO., LTD., TAINAN CITY (TW)

(72) Inventor: PEN-WEI CHEN, TAINAN CITY (TW)

(21) Appl. No.: 18/482,084

(22) Filed: Oct. 6, 2023

(51) Int. Cl. G02C 9/04; G02C 5/14

(52) U.S. Cl. CPC G02C 9/04; G02C 5/146; G02C 2200/04

(57) ABSTRACT

The invention relates to a temple side wing structure, which forms an embedding groove recessed at the temples near the lower end of the lens. Each embedding groove has an embedding hole portion located at the rear thereof, and a hooking hole portion connected with the embedding hole portion at the front thereof. Each side shield has an embedding section protruding from the upper end thereof. The embedding section has an embedding portion formed at the rear end thereof corresponding to the embedding hole portion. The front end of the embedding section has a hooking portion connected with the embedding portion. The hooking portion and the hooking hole portion are hooked and combined for positioning. The user can choose different shapes and colors of the side shields according to their own preferences and needs, and then assemble and fix the selected side shields on both sides of the spectacle frame.

### BACKGROUND OF THE PRESENT INVENTION

### Field of Invention

The present invention relates to a temple side wing structure, and in particular to a side shield structure that allows users to choose different shapes and color styles of side shields according to their preferences. The selected side shields are assembled and fixed on both sides of the frame, so that when the user wears the glasses, the side shields can be used to cover and fit around the user's eyes, which can prevent strong winds and prevent foreign objects from contacting the eyes, thus achieving the effect of protecting the eyes. It also has a beautiful visual effect and increases the competitiveness of its products. The innovative design of temple side wing structure further enhances practical effectiveness and characteristics in its overall implementation and use.

### Description of Related Arts

Common types of glasses can be roughly divided into optical glasses, sunglasses, sports glasses, night vision protective glasses, etc. in terms of function for users to choose and wear according to different times and different needs, so that most existing consumers usually have multiple pairs of glasses with different functions for easy replacement.

Among them, people are generally accustomed to wearing various types of goggles in order to protect their eyes from being hit by strong winds or being injured by collisions with foreign objects when engaging in certain jobs or performing high-speed activities. The covering portions of this type of goggles formed on both sides of the frame cover and fit around the user's eyes to prevent strong wind and foreign objects from contacting the eyes, thus achieving the effect of protecting the eyes.

However, although the above-mentioned goggles can provide users with the expected effect of protecting their eyes from strong winds and foreign object contact when worn, it has also been found in its actual operation and use that the covering portions provided on both sides of the frame of these types of goggles are directly extended and integrally formed on both sides of the frame, resulting in an extremely monotonous overall shape and color. Users cannot choose and match according to their preferences, which leads to the inability to effectively enhance the competitiveness of the product and still leaves room for improvement in the overall structural design.

In view of this, the inventor has relied on many years of rich design, development and actual production experience in this related industry, researched and improved the existing structure and deficiencies, and provided a temple side wing structure in order to achieve better practical value.

### SUMMARY OF THE PRESENT INVENTION

The main purpose of this invention is to provide a temple side wing structure that allows users to choose different shapes and colors for side shields according to their preferences and needs, and then the selected side shields are then assembled and fixed on both sides of the spectacle frame, so that when the user wears the glasses, the side shields can be used to cover and fit around the user's eyes, not only preventing strong wind and foreign objects from touching the eyes and achieving eye protection but also having aesthetic visual effects and increasing product competitiveness. Furthermore, it improves practical effectiveness and characteristics in its overall implementation and usage.

The main purpose and effect of the temple side wing structure of the present invention are achieved by the following specific technical means,
which mainly include a spectacle frame and side shields, wherein
the spectacle frame has lenses arranged thereon, corresponding temples pivoted on both sides of the spectacle frame, and embedding grooves respectively recessed to form each temple close to the lower end of the lens, wherein each of the embedding grooves has an embedding hole portion located at the rear thereof, wherein each of the embedding grooves has a hooking hole portion connected with the embedding hole portion at the front thereof, wherein
each side shield has an embedding section protruding from the upper end thereof, corresponding to the embedding groove at the lower end of each of the temples, wherein the embedding section has an embedding portion formed at the rear end thereof corresponding to the embedding hole portion for positioning and interlocking, wherein the front end of the embedding section has a hooking portion connected with the embedding portion, wherein the hooking portion is used to hook and combine with the hooking hole portion for positioning.

The preferred embodiment of the temple side wing structure of the present invention, the embedding hole portion is diagonally concave.

The preferred embodiment of the temple side wing structure of the present invention, an inclined guide end surface is formed on the front edge of the hooking portion.

### BRIEF DESCRIPTION OF THE DRAWINGS

FIG. 1 is an exploded view according to the present invention.

FIG. 2 is a partially exploded view according to the present invention.

FIG. 3 is an assembled perspective view according to the present invention.

FIG. 4 is a side-assembled sectional view according to the present invention.

FIG. 5 is a partially enlarged side-assembled sectional view according to the present invention.

### DETAILED DESCRIPTION OF THE PREFERRED EMBODIMENT

In order to have a more complete and clear disclosure of the technical content, the purpose of creation and the effect achieved by the present invention, it is explained in detail below, and refer to the disclosed drawings and drawing numbers together:

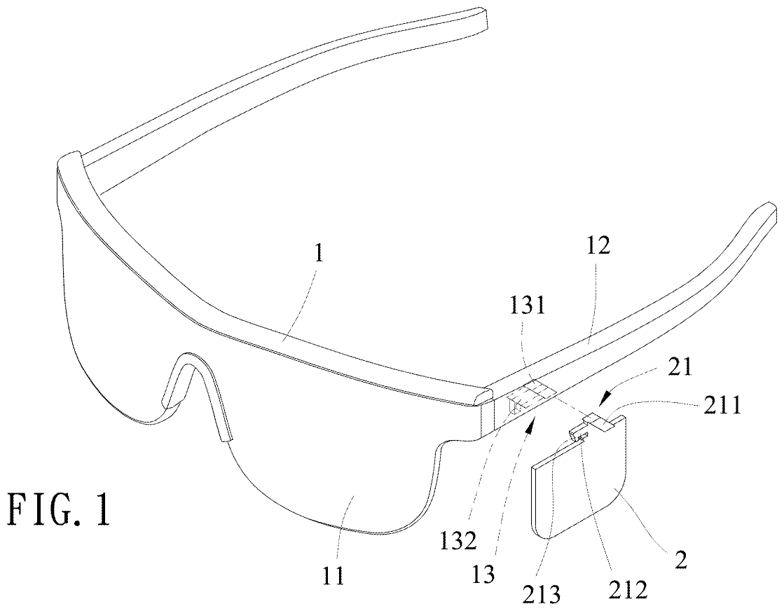

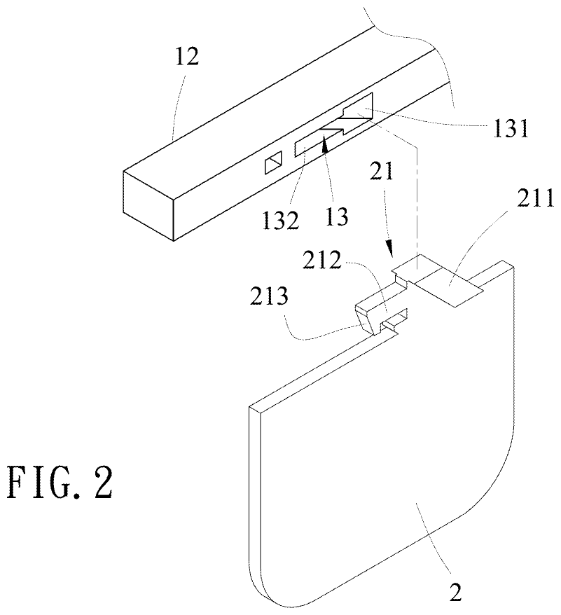

First, referring to FIG. 1 which is an exploded perspective view of the present invention and FIG. 2 which is a partially exploded perspective view of the present invention. The present invention mainly includes a spectacle frame (1) and two side shields (2), wherein
the spectacle frame (1) has lenses (11) arranged thereon, corresponding temples (12) pivoted on both sides of the spectacle frame (1), and embedding grooves (13) respectively recessed to form each temple close to the lower end of the lens (11), wherein each of the embedding grooves (13) has an embedding hole portion (131) obliquely recessed at the rear thereof, wherein each of the embedding grooves (13) has a hooking hole portion (132) connected with the embedding hole portion (131) at the front thereof, wherein
each side shield (2) has an embedding section (21) protruding from the upper end thereof, corresponding to the embedding groove (13) at the lower end of each of the temples (12), wherein the embedding section (21) has an embedding portion (211) at the rear end thereof corresponding to the obliquely recessed embedding hole portion (131) for positioning and interlocking, wherein the front end of the embedding section (21) has a hooking portion (212) connected with the embedding portion (211), and an inclined guide end surface (213) forms the front edge of the hooking portion (212).

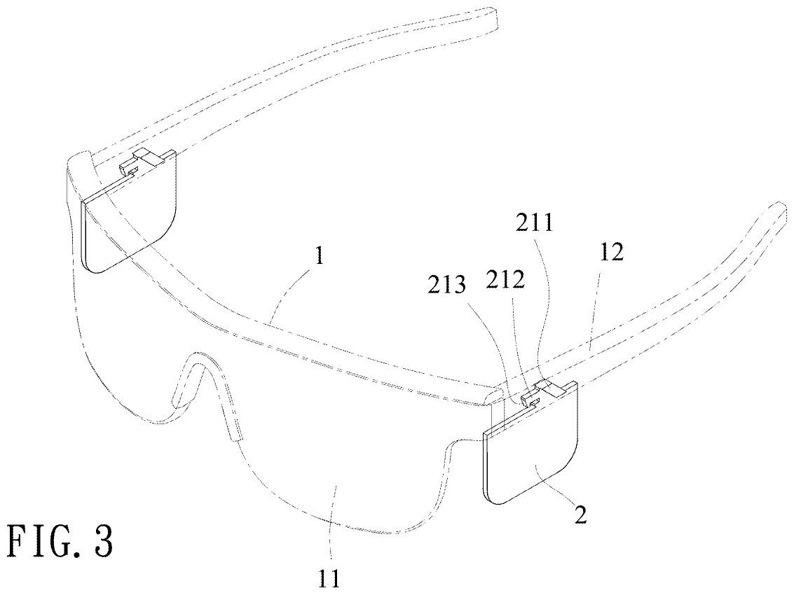

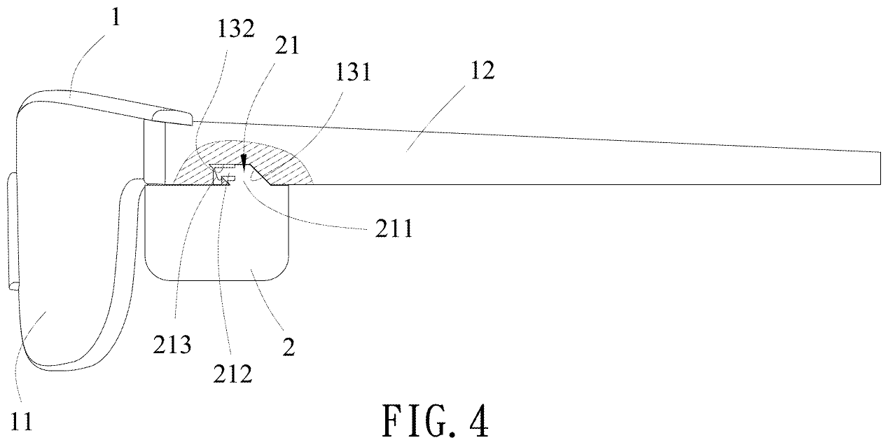

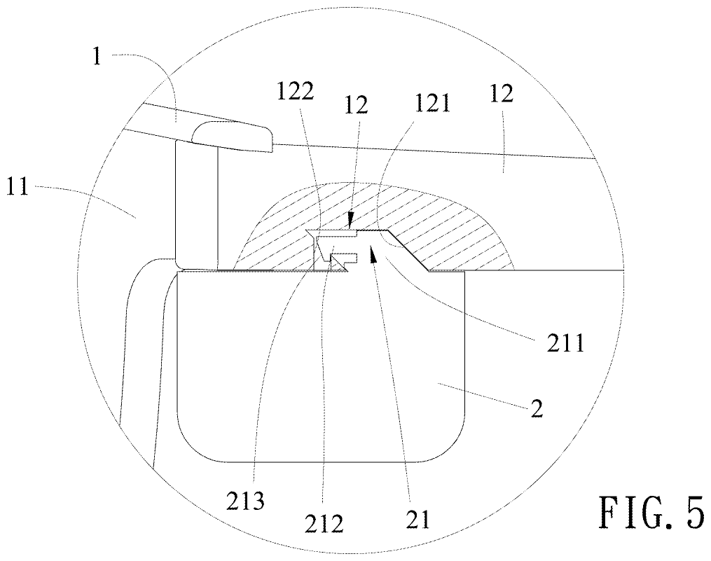

Thus, referring to FIG. 3, which is an assembled perspective view of the present invention, FIG. 4, which is a side assembled perspective view of the present invention, and FIG. 5, which is a partially enlarged side assembled sectional perspective view of the present invention, the present invention can choose the style of the side shields (2) to be matched to the spectacle frame (1) according to the preferences and needs of the user, and the selected side shield (2) correspondingly embedded into the embedding groove (13) at the lower end of the temple (12) by the embedding section (21) and positioned by the embedding portion (211) inserted into the embedding hole portion (131), while the hooking portion (212) is hooked and fixed combined with the hooking hole portion (132), wherein the front edge of the hooking portion (212) forms an inclined guide end surface (213), so that the hooking portion (212) to have a guiding effect during the insertion into the hooking hole portion (132), which is more convenient for the insertion and positioning of the hook fixing combination, so that the side shields (2) can be fixed to both sides of the spectacle frame (1). When the user wears glasses, the side shields (2) can be used to cover and fit around the user's eyes, preventing strong winds and foreign objects from contacting the eyes and achieving the effect of protecting the eyes.

By the above description, the implementation of the present invention can be understood. Compared with the conventional technical means, the invention mainly allows users to choose different shapes and color patterns of side shields according to their preferences and needs. Then, the selected side shields are assembled and fixed on both sides of the spectacle frame. When the user wears glasses, the side shields can be used to cover and fit around the user's eyes, not only preventing strong wind and foreign objects from touching the eyes and achieving eye protection but also having aesthetic visual effects and increasing product competitiveness. Moreover, it also enhances practicality and effectiveness in overall use.

What is claimed is:

1. A temple side wing structure, which mainly comprises a spectacle frame and side shields, wherein
the spectacle frame has lenses arranged thereon, corresponding temples pivoted on both sides of the spectacle frame, and embedding grooves respectively recessed to form each temple close to the lower end of the lens, wherein each of the embedding grooves has an embedding hole portion located at the rear thereof, wherein each of the embedding grooves has a hooking hole portion connected with the embedding hole portion at the front thereof, wherein
each side shield has an embedding section protruding from the upper end thereof, corresponding to the embedding groove at the lower end of each of the temples, wherein the embedding section has an embedding portion formed at the rear end thereof corresponding to the embedding hole portion for positioning and interlocking, wherein the front end of the embedding section has a hooking portion connected with the embedding portion, wherein the hooking portion is used to hook and combine with the hooking hole portion for positioning.

2. The temple side wing structure as claimed in claim 1, wherein the embedding hole portion is diagonally concave.

3. The temple side wing structure as claimed in claim 1, wherein an inclined guide end surface is formed on the front edge of the hooking portion.
